(19) United States
(12) Patent Application Publication
(10) Pub. No.: US 2022/0405524 A1
(43) Pub. Date: Dec. 22, 2022

(54) OPTICAL CHARACTER RECOGNITION TRAINING WITH SEMANTIC CONSTRAINTS

(71) Applicant: INTERNATIONAL BUSINESS MACHINES CORPORATION, Armonk, NY (US)

(72) Inventors: Zhong Fang Yuan, Xian (CN); Tong Liu, Xian (CN); Jing Wen Xu, Shanghai (CN); Xiang Yu Yang, Xian (CN); Yu Pan, Shanghai (CN); Wei NB Wu, NING BO (CN)

(21) Appl. No.: 17/350,060

(22) Filed: Jun. 17, 2021

(51) Int. Cl. G06K 9/62; G06K 9/34; G06N 3/08

(52) U.S. Cl. CPC G06K 9/623; G06K 9/6256; G06K 9/344; G06N 3/08; G06K 2209/01

(57) ABSTRACT

A method, computer system, and a computer program product for optical character recognition training are provided. A text image and plain text labels for the text image may be received. The text image may include words. The plain text labels may include machine-encoded text corresponding to the words. Semantic feature vectors for the words, respectively, may be generated based on the plain text label. The text image, the plain text labels, and the semantic feature vectors may be input together into a machine learning model to train the machine learning model for optical character recognition. The plain text labels and the semantic feature vectors may be constraints for the training.

### BACKGROUND

The present invention relates generally to optical character recognition, particularly to the conversion of text images into machine-encoded text.

### SUMMARY

According to one exemplary embodiment, a method for optical character recognition training is provided. A text image and plain text labels for the text image are received. The text image includes words. The plain text labels include machine-encoded text corresponding to the words. Semantic feature vectors for the words, respectively, are generated based on the plain text label. The text image, the plain text labels, and the semantic feature vectors are input together into a machine learning model to train the machine learning model for optical character recognition. The plain text labels and the semantic feature vectors are constraints for the training. A computer system and computer program product corresponding to the above method are also disclosed herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a semantic constraint optical character recognition training process according to at least one embodiment;

FIG. 3 is a block diagram of internal and external components of computers, phones, and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a system, method, and computer program product for training a machine learning model with semantic constraints training in addition to optical character recognition (OCR) training. The present embodiments help an improved OCR model to be obtained that has the ability to correctly recognize characters despite fuzziness or occlusion in a text image for one or more characters. The present embodiments also make an improved process to train an OCR model by combining OCR training and semantic constraint training while developing and training an OCR model. Thus, with the enhanced OCR training process described in the present embodiments training of the OCR model can be enhanced in a simplified manner by simultaneously training the model to reduce losses for conventional OCR features and to reduce losses for semantic factors for words in the received text image. The resulting trained machine learning model improves artificial intelligence by allowing semi-blurred text from printed documents or from captured images to be more accurately recognized. The accurately recognized text may then be used for word processing, automated word searching, artificial intelligence question and answer, for generating user recommendations, for sentiment analysis, for information extraction, text classification, machine translation, etc.

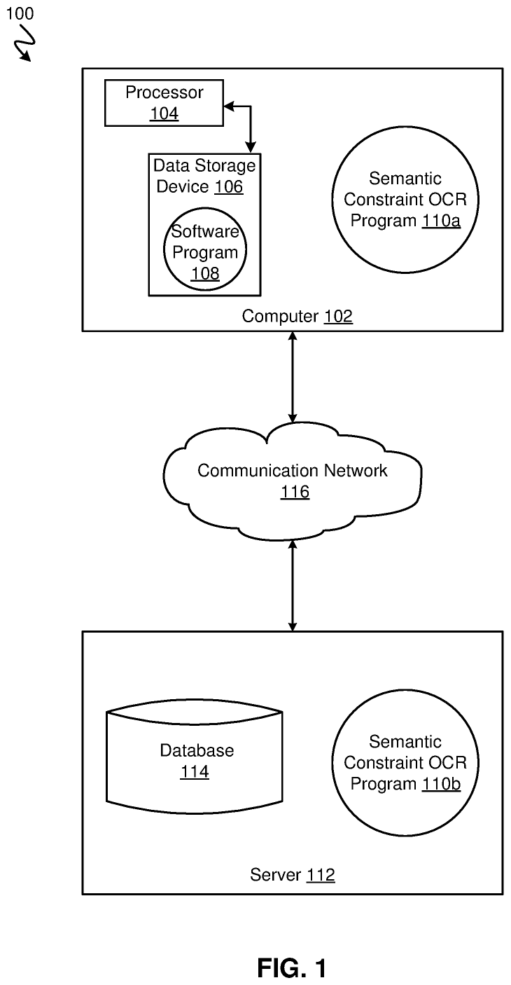

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a semantic constraint-enhanced OCR program 110a. The networked computer environment 100 may also include a server 112 that is a computer and that is enabled to run a semantic constraint-enhanced OCR program 110b that may interact with a database 114 and a communication network 116. The networked computer environment 100 may include a plurality of computers 102 and servers 112, although only one computer 102 and one server 112 are shown in FIG. 1. The communication network 116 allowing communication between the computer 102 and the server 112 may include various types of communication networks, such as the Internet, a wide area network (WAN), a local area network (LAN), a telecommunication network, a wireless network, a public switched telephone network (PTSN) and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

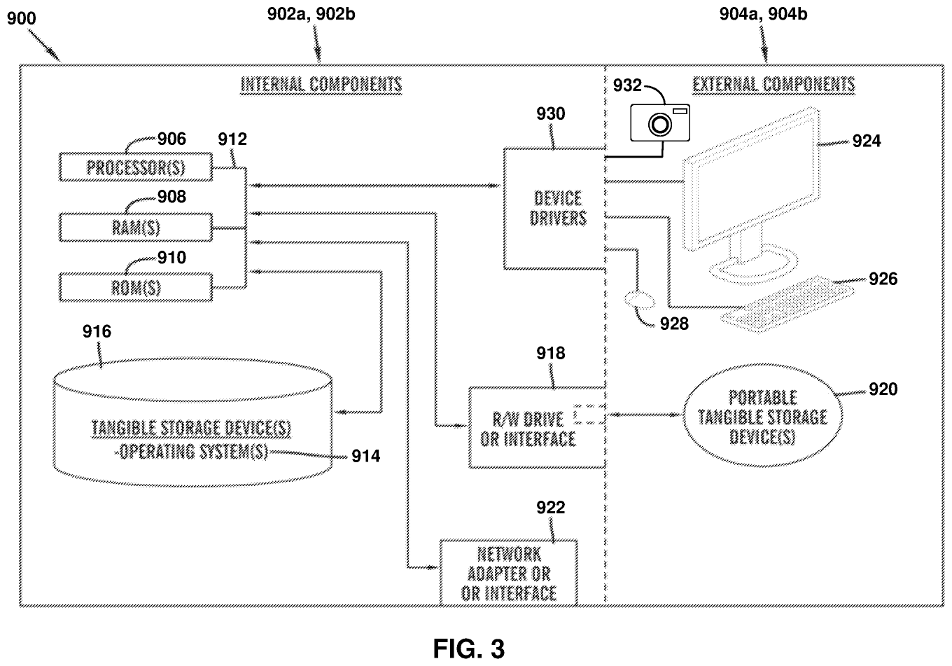

The client computer 102 may communicate with the server 112 via the communication network 116. The communication network 116 may include connections, such as wire, wireless communication links, or fiber optic cables. As will be discussed with reference to FIG. 3, server 112 may include internal components 902a and external components 904a, respectively, and client computer 102 may include internal components 902b and external components 904b, respectively. Server 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114 in a server 112 that is remotely located with respect to the client computer 102. The client computer 102 will typically be mobile and include a display screen and a camera. According to various implementations of the present embodiment, the semantic constraint-enhanced OCR program 110a, 110b may interact with a database 114 that may be embedded in various storage devices, such as, but not limited to a computer/mobile device 102, a networked server 112, or a cloud storage service.

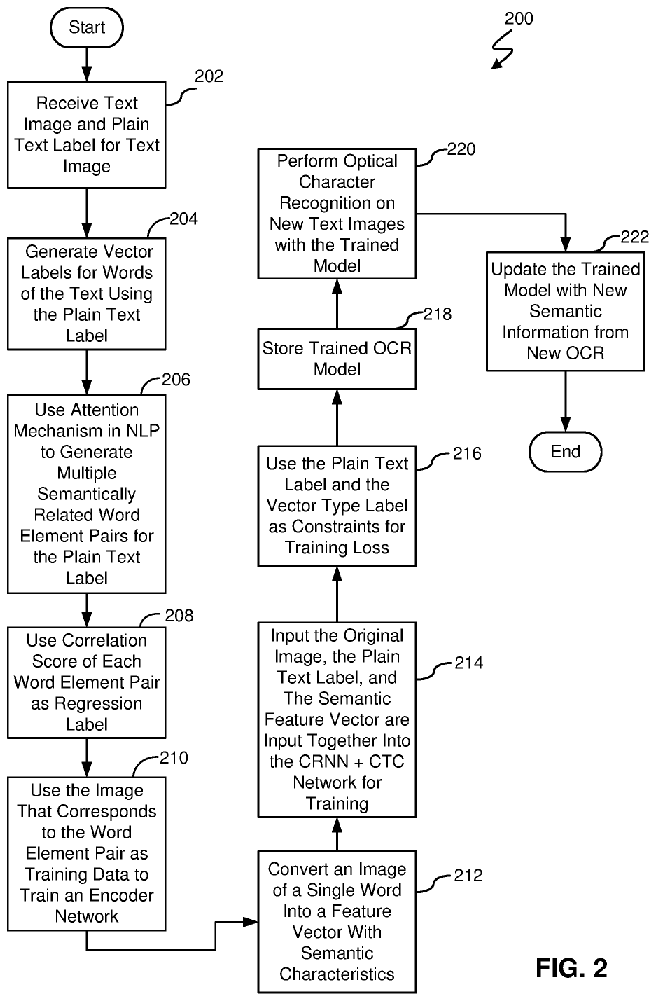

Referring now to FIG. 2, an operational flowchart depicts a semantic constraint-enhanced OCR training process 200 that may, according to at least one embodiment, be performed to generate the semantic constraint-enhanced OCR program 110a, 110b. A computer system with the semantic constraint-enhanced OCR program 110a, 110b operates as a special purpose computer system in which the semantic constraint-enhanced OCR program 110a, 110b achieves improved optical character recognition. In particular, the semantic constraint-enhanced OCR program 110a, 110b transforms a computer system into a special purpose computer system as compared to currently available general computer systems that do not have the semantic constraint-enhanced OCR program 110a, 110b.

With the semantic constraint-enhanced OCR training process 200, global-level semantic features may be introduced in units of text behaviors, so that long and fuzzy lines of text are effectively inferred from the semantic features of the full text in addition to being recognized by OCR picture or glyph recognition.

In a step 202 of the semantic constraint-enhanced OCR training process 200, a text image and plain text label for the text image are received. Although text images for OCR may often be received by capturing an image with a camera or a digital scanner, step 202 occurs as part of OCR training. Thus, the text image for many embodiments may be received by receiving a file in a digital format. The receiving of the text image and the plain text label may occur via the communication network 116 that is shown in FIG. 1. The receiving may occur via an uploaded file being received at the computer 102 or at the server 112 after the file is transmitted via the communication network 116, e.g., was transmitted from the computer 102 through the communication network 116 to the server 112.

The text image may include words. Some of those words may have a fuzzy, blurred, or occluded depiction which makes traditional optical character recognition more challenging. Due to unclear letters in the text image or due to the text image of the words having a low quality image, a conventional OCR program may struggle to recognize some of the words in the text image, e.g., whether a word is “IBM” or “I8M” or if another word is “blurred” or “bhured”. A conventional OCR program may rely on extracting features from a glyph level for identification and by calculating a loss value based on shape differences in the image characters.

The text image may be received as a RAW file, a TIFF file, a JPEG file, or as some other file type configured to store a picture or an image.

The plain text label that is received may include machine-encoded text that corresponds to the words in the text image. For example, the text image may be a picture of a maximum occupancy sign that is displayed in a building. The corresponding plain text label for the text image of this maximum occupancy sign may be “Occupancy By More Than 130 Persons Is Dangerous And Unlawful”. In another example, the text image may include one or more pictures of one or more pages of an academic article. The corresponding plain text label for the image of this academic article is the machine-encoded text of all of the words and pages of the article.

The plain text label may be received as a word processing file or some other file type configured to contain machine-encoded text.

The receiving of the text image together with the plain text label is conducive for other steps of the semantic constraint-enhanced OCR training process 200 which use the plain text label for both glyph-based training and for semantic training for the OCR model. Inputting expansive data sets such as encyclopedia sets or long books into the model for semantic training may be rendered unnecessary by using the plain text label for both glyph-based training and for semantic training instead of for glyph-based training alone. Glyph-based training includes helping an OCR model match machine-encoded text with pictures of text so that the model may learn to classify text by analyzing the glyph form of a character.

In a step 204 of the semantic constraint-enhanced OCR training process 200, vector labels for words of the text are generated using the plain text label. A natural language processing algorithm that generates word embeddings may be used to perform step 204. Word embeddings may be an instance of distributed representation, with each word in an examined text body being its own one-dimensional vector. In word embeddings, based on the machine learning, words with similar meanings may be generated to have similar vectors. For example, a natural language processing algorithm may analyze a text body of machine-encoded text and recognize that the words “man” and “woman” have similar usage in the text body as nouns/subjects/agents. The NLP algorithm may generate similar vectors to represent these two similar words.

Word embeddings may be a dimensional space that may include vectors. When the words from the text corpus are represented as vectors in the dimensional space, mathematical operations may be performed on the vectors to allow quicker and computer-based comparison of text corpora. The word embeddings may also reflect the size of the vocabulary of the respective text corpus or of the portion of the text corpus fed into the embedding model, because a vector may be kept for each word in the vocabulary of the text corpus that is fed in or of the text corpus portion that is fed in. This vocabulary size is separate from the dimensionality. For example, a word embedding for a large text corpus may have one hundred dimensions and may have one hundred thousand respective vectors for one hundred thousand unique words. The dimensions for the word embedding may relate to how each word in the text corpus relates to other words in the text corpus.

The semantic constraint-enhanced OCR program 110a, 110b may have or may access a neural network with the natural language processing algorithm in order to perform step 204. A pre-trained NLP model such as Word2vec, gloVe, BERT, RoBERTa, and ELMO may be used to generate the word embeddings and vectors for performing step 204. This vector-producing program may be a two-layer neural net that receives a text corpus as input and which produces a set of vectors as output with these feature vectors representing words in that text corpus. This vector-producing program detects similarities in the words mathematically. Given training with sufficient data, usage, and contexts, the vector-producing program may make highly accurate guesses about semantic meaning of a word based on past appearances. These guesses may establish associations of a word with other words in the text corpus that is examined.

In a step 206 of the semantic constraint-enhanced OCR training process 200, an attention mechanism in natural language processing is used to generate multiple semantically related word element pairs for the plain text label. The processor 104 may readily be able to recognize the machine-encoded text that is include with the plain text label. Step 206 may be performed via the vector-producing mechanism that performs step 204.

The vector-producing algorithm may include an attention mechanism which utilizes intermediate encoder states for encoders of a neural network. An attention mechanism improved over encoder decoder-based neural machine translation systems which ignored the intermediate encoder states. A feed forward neural network with an attention mechanism may use mathematical analysis to recognize words in a text corpus which have higher relevance and connection to each other. The NLP program may analyze a sentence “Is this line of words getting blurred?” to determine which words in the sentence have a stronger relation to each other. In performing step 206, the semantic constraint-enhanced OCR training process 200 may recognize that the word elements “words” and “blurred” have the strongest relationship to each other of all words in the above-mentioned sentence that is analyzed. The semantic constraint-enhanced OCR training process 200 recognizes those words with higher importance in a sentence and assigns greater weights to those words for passing to further encoding layers.

In a step 208 of the semantic constraint-enhanced OCR process 200, a correlation score of each word element pair is used as a regression label. The word element pair refers to the characters, word elements, and/or words of the plain text label which is received as machine-encoded text and, thereby, is easily recognizable by a computer, e.g., by a program using the processor 104. For the example sentence “Is this line of words getting blurred?”, each word in the sentence may be matched with each other word in the sentence to numerically measure semantic similarity and semantic relationships between the words. Words in other sentences of the text corpus of the plain text label may also be numerically analyzed to determine semantically similar words that relate similarly to other words of the text corpus.

The vector-producing program may utilize a cosine similarity discriminator which performs a cosine similarity measurement to perform step 208. With the cosine similarity measurement, no similarity between two words of a text corpus may be expressed as a 90 degree angle, while total similarity between two words of the text corpus may be considered a 0 degree angle and have complete overlap. In the above-provided example sentence, the two words “words” and “blurred” may be determined to have a cosine similarity of 0.53.

A regression label may be used in supervised machine learning to predict continuous values. For the step 208, the regression label may be used to predict, as continuous values, cosine similarity scores between words and/or word elements of the text corpus of the plain text label.

In a step 210 of the semantic constraint-enhanced OCR training process 200, the image that corresponds to the word element pair is used as training data to train an encoder network. The encoder network may be part of a recurrent neural network. The encoder network may include a plurality of encoder layers. An encoder may condense an input sequence into a vector. The encoder network may include one or more hidden states. Each hidden state may map a previous inner hidden state and a previous target vector to a current inner hidden state and a logit vector.

In a step 212 of the semantic constraint-enhanced OCR training process 200, an image of a single word is converted into a feature vector with semantic characteristics. The encoder network that is trained in step 210 may perform the conversion of step 212. The step 212 may include extraction that starts from an initial set of measured data and then builds derived values, called features. These features may be informative and non-redundant and may facilitate subsequent learning steps and generalization steps. Feature extraction is related to dimensionality reduction. When the input data to an algorithm is too large to be processed and is suspected to be redundant, then the input data is transformed into a reduced set of features named a feature vector. Selecting the features may include determining a subset of the initial features. The selected features should contain relevant information from the input data, so that the desired task can be performed by using this reduced representation instead of the complete initial data. The semantic constraint-enhanced OCR training program 110a, 110b may perform the conversion into the feature vector.

In a step 214 of the semantic constraint-enhanced OCR training process 200, the original image, the plain text label, and the semantic feature vector are input together into a CRNN+CTC network for training. The inputting may occur via a multiple-channel, e.g., a dual-channel, feature input method. The CRNN+CTC network is a convolutional recurrent neural network (CRNN) and a connectionist temporal classification function (CTC). The input data being input together may mean that these inputs, i.e., the original text image the plain text label, and the semantic feature vector, are input simultaneously into the CRNN+CTC. A CRNN+CTC is a backbone architecture for optical character recognition (OCR). For step 214, an untrained or partially-trained CRNN+CTC architecture may be instantiated by the semantic constraint-enhanced OCR program 110a, 110b in order to train the CRNN+CTC architecture.

A CRNN of the CRNN+CTC architecture includes one or more convolutional layers and one or more recurrent layers. The CRNN may also implement long short-term memory (LSTM). Multiple convolutional layers, e.g., seven or more convolutional layers, may be stacked and then followed by multiple LSTM layers, e.g., three LSTM layers. In some embodiments, the CRNN may be a deep learning model. The convolutional layers may extract relevant features from the input by using filters that are chosen randomly and trained like weights. The filters may include matrices. These matrices in some embodiments may slide over an image, e.g., over the text image. The filters may identify the most important portions of the text image. The recurrent layers function for prediction to help the architecture to model sequence data. In the recurrent layers, the information cycles through a loop. With the looping, the neuron in a recurrent layer adds the immediate past to the present to achieve better prediction. The recurrent layers apply weights to the current input and to the previous input. The recurrent layers may be considered a sequence of neural networks that are trained one after the other via backpropagation.

CTC helps avoid the need for an aligned dataset to make optical character recognition possible for a misaligned set of characters. The CTC outputs a matrix that is a character-score for each time-step. The matrix may then be used to calculate the loss and to decode output. Using the CTC helps avoid character duplication for characters that take up more than one time-step. For calculating loss, all possible alignment scores of a ground truth are summed up. Corresponding character scores may be multiplied together to get the score for one path. For getting the score corresponding to a given ground truth, scores of all the paths to the corresponding text may be summed up. The probability of the ground truth occurring is determined. The loss is the negative logarithm of the probability. The loss can be back-propagated and the network can be trained. The CTC may also help with decoding once the CRNN is trained. The CTC may help identify the most likely text given an output matrix of the CRNN. A best path algorithm may be calculated to achieve computation reduction by considering the character with max probability at every time-step and by removing blanks and duplicate characters, which results in the actual text.

In a step 216 of the semantic constraint-enhanced OCR training process 200, the plain text label and the vector type label are used as constraints for training loss. Thus, backpropagation may be performed to reduce the loss and to identify max probability text using both the plain text label and the vector type label. Thus, the semantic meanings and word embeddings, represented by the semantic feature vectors, may be harnessed as a constraint to train the model and reduce loss, in addition to the plain text label being used as a constraint for reducing loss.

In a step 218 of the semantic constraint-enhanced OCR training process 200, a trained optical character recognition (OCR) model is stored. The OCR model obtained by the training and performance of steps 202 to 216 may produce an enhanced OCR model. This enhanced OCR model may be stored in the data storage device 106 of the computer 102, in a database 114 of the server 112, or in another remote location with computer data storage that is accessible to the computer 102 and/or the server 112 via the communication network 116.

In a step 220 of the semantic constraint-enhanced OCR training process 200, optical character recognition is performed on new text images with the trained model. Due to the training, the trained OCR model is able to achieve improved OCR ability to recognize text that is input without labels. The new text images are different from the text image that was received with the plain text label in step 202. The new text images may be input into the trained model and machine-encoded text for the text in the images may be generated as the output of the trained model. The accurately recognized text may then be used for word processing, automated word searching, artificial intelligence question and answer, for generating user recommendations, for sentiment analysis, for information extraction, text classification, machine translation, etc. The new text images may be captured via the camera 932 or via a scanner connected to the computer 102. To perform the additional optical character recognition in step 220, a trained OCR model that was trained in steps 202 to 218 may be instantiated by the semantic constrain-enhanced OCR program 110a, 110b.

In a step 222 of the semantic constraint-enhanced OCR training process 200, the trained model is updated with new semantic information from the new optical character recognition that was performed in step 220. The trained model may continually be updated by receiving new text to analyze in order to improve its semantic feature guessing.

By using the plain text label to perform loss reduction for a string label as well as using the plain text label to perform loss reduction for a vector label, training an improved OCR model may occur more efficiently. This use of a plain text label for both a string label and a vector label may occur via the text image, the plain text label for supervised training for the text image, and a word embedding/semantic feature vector being input simultaneously and/or together into the machine learning model. The resulting trained machine learning model improves artificial intelligence by allowing the artificial intelligence to more accurately recognize blurry text or occluded text from printed documents or from captured images. Texts with similar shapes which have traditionally easily confused an OCR system may be readily recognized with the semantic constraint-enhanced OCR program 110a, 110b OCR system that is produced with the semantic constraint-enhanced OCR training process 200.

It may be appreciated that FIG. 2 provides only illustrations of some embodiments and does not imply any limitations with regard to how different embodiments may be implemented. Many modifications to the depicted embodiment(s), e.g., to a depicted sequence of steps, may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902a, 902b, 904a, 904b is representative of any electronic device capable of executing machine-readable program instructions. Data processing system 902a, 902b, 904a, 904b may be representative of a smart phone, a computer system, PDA, or other electronic devices. Examples of computing systems, environments, and/or configurations that may represented by data processing system 902a, 902b, 904a, 904b include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

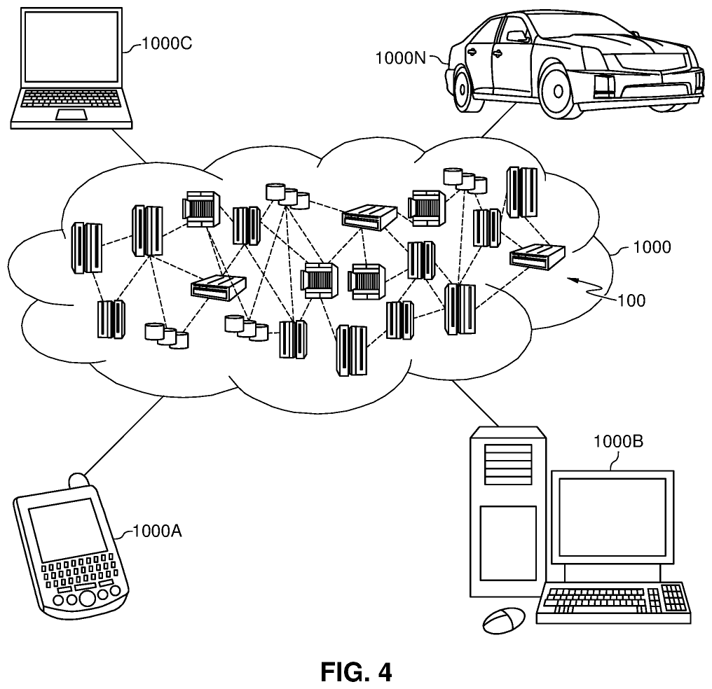

User client computer 102 and server 112 may include respective sets of internal components 902a, 902b and external components 904a, 904b illustrated in FIG. 4. Each of the sets of internal components 902a, 902b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108a, and the semantic constraint-enhanced OCR program 110a in client computer 102, the software program 108b and the semantic constraint-enhanced OCR program 110b in server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory, or any other computer-readable tangible storage device that can store a computer program and digital information.

Each set of internal components 902a, 902b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108a, 108b and the semi-automated long answer exam evaluation program 110a, 110b can be stored on one or more of the respective portable computer-readable tangible storage devices 920, read via the respective R/W drive or interface 918 and loaded into the respective hard drive 916.

Each set of internal components 902a, 902b may also include network adapters (or switch port cards) or interfaces 922 such as a TCP/IP adapter cards, wireless wi-fi interface cards, or 3G or 4G wireless interface cards or other wired or wireless communication links. The software program 108a and the semi-automated long answer exam evaluation program 110a in client computer 102, the software program 108b and the semi-automated long answer exam evaluation program 110b in the server 112 can be downloaded from an external computer (e.g., server) via a network (for example, the Internet, a local area network or other, wide area network) and respective network adapters or interfaces 922. From the network adapters (or switch port adaptors) or interfaces 922, the software program 108a, 108b and the semantic constraint-enhanced OCR program 110a in client computer 102 and the semantic constraint-enhanced OCR program 110b in server 112 are loaded into the respective hard drive 916. The network may include copper wires, optical fibers, wireless transmission, routers, firewalls, switches, gateway computers and/or edge servers.

Each of the sets of external components 904a, 904b can include a computer display monitor 924, a keyboard 926, a computer mouse 928, and a camera 932. External components 904a, 904b can also include touch screens, virtual keyboards, touch pads, pointing devices, and other human interface devices. Each of the sets of internal components 902a, 902b also includes device drivers 930 to interface to computer display monitor 924, keyboard 926, computer mouse 928, and camera 932. The device drivers 930, R/W drive or interface 918 and network adapter or interface 922 include hardware and software (stored in storage device 916 and/or ROM 910). A scanner may be an external component 904a, 904b. The device drivers 930 may include a device driver for a scanner.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1900 can communicate with any type of computerized device over any type of network and/or network addressable connection (e.g., using a web browser).

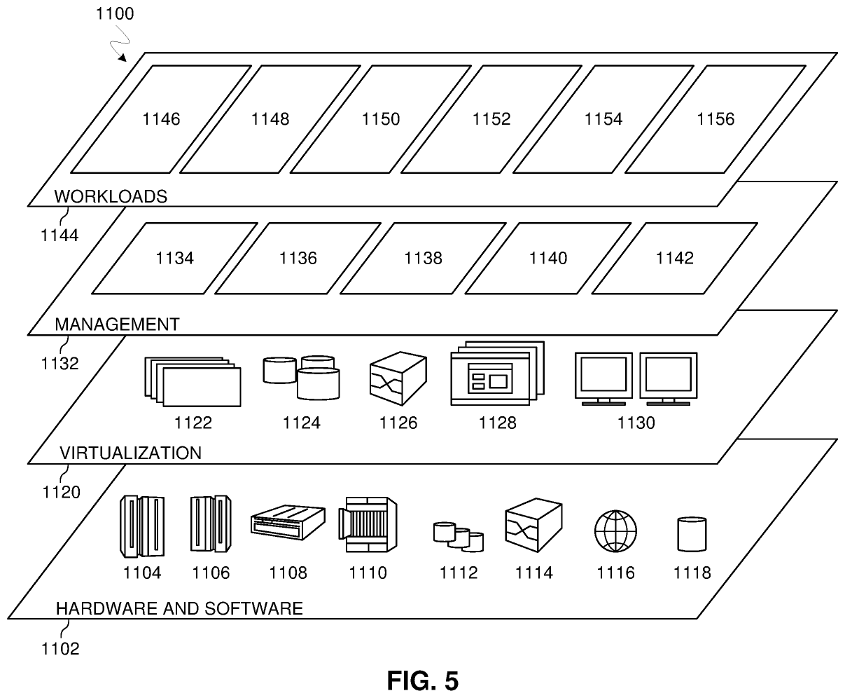

Referring now to FIG. 5, a set of functional abstraction layers 1100 provided by cloud computing environment 1000 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and semantic constraint-enhanced optical character recognition 1156. A semantic constraint-enhanced OCR program 110a, 110b provides a way to improve optical character recognition of texts having fuzzy or occluded text or characters.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optical character recognition model training, the method comprising:
receiving a text image and plain text labels for the text image, the text image comprising words, and the plain text labels comprising machine-encoded text corresponding to the words;
generating semantic feature vectors for the words, respectively, based on the plain text labels; and
inputting the text image, the plain text labels, and the semantic feature vectors together into a machine learning model to train the machine learning model for optical character recognition, wherein the plain text labels and the semantic feature vectors are constraints for the training.

2. The method of claim 1, further comprising:
reducing loss for the plain text label and for the semantic feature vectors to train the machine learning model.

3. The method of claim 1, wherein the machine learning model comprises at least one member selected from the group consisting of a convolutional recurrent neural network and a connectionist temporal classification function.

4. The method of claim 1, wherein the generating the semantic feature vectors comprises inputting the received plain text labels into an attention mechanism.

5. The method of claim 4, wherein the attention mechanism generates correlation scores for word element pairs of the plain text label.

6. The method of claim 5, wherein the generating the semantic feature vectors further comprises using the correlation scores as a regression label.

7. The method of claim 1, wherein the generating the semantic feature vectors comprises inputting the plain text labels into at least one member selected from the group consisting of an encoder and a cosine similarity discriminator.

8. A computer system for optical character recognition model training, the computer system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving a text image and plain text labels for the text image, the text image comprising words, and the plain text labels comprising machine-encoded text corresponding to the words;
generating semantic feature vectors for the words, respectively, based on the plain text labels; and
inputting the text image, the plain text labels, and the semantic feature vectors together into a machine learning model to train the machine learning model for optical character recognition, wherein the plain text labels and the semantic feature vectors are constraints for the training.

9. The computer system of claim 8, wherein the method further comprises:
reducing loss for the plain text label and for the semantic feature vectors to train the machine learning model.

10. The computer system of claim 8, wherein the machine learning model comprises at least one member selected from the group consisting of a convolutional recurrent neural network and a connectionist temporal classification function.

11. The computer system of claim 8, wherein the generating the semantic feature vectors comprises inputting the received plain text labels into an attention mechanism.

12. The computer system of claim 11, wherein the attention mechanism generates correlation scores for word element pairs of the plain text label.

13. The computer system of claim 12, wherein the generating the semantic feature vectors further comprises using the correlation scores as a regression label.

14. The computer system of claim 8, wherein the generating the semantic feature vectors comprises inputting the plain text labels into at least one member selected from the group consisting of an encoder and a cosine similarity discriminator.

15. A computer program product for optical character recognition training, the computer program product comprising a computer-readable storage medium having program instructions embodied therewith, wherein the program instructions are executable by a computer system to cause the computer system to perform a method comprising:
receiving a text image and plain text labels for the text image, the text image comprising words, and the plain text labels comprising machine-encoded text corresponding to the words;
generating semantic feature vectors for the words, respectively, based on the plain text labels; and
inputting the text image, the plain text labels, and the semantic feature vectors together into a machine learning model to train the machine learning model for optical character recognition, wherein the plain text labels and the semantic feature vectors are constraints for the training.

16. The computer program product of claim 15, further comprising:
reducing loss for the plain text label and for the semantic feature vectors to train the machine learning model.

17. The computer program product of claim 15, wherein the machine learning model comprises at least one member selected from the group consisting of a convolutional recurrent neural network and a connectionist temporal classification function.

18. The computer program product of claim 15, wherein the generating the semantic feature vectors comprises inputting the received plain text labels into an attention mechanism.

19. The computer program product of claim 18, wherein the attention mechanism generates correlation scores for word element pairs of the plain text label.

20. The computer program product of claim 19, wherein the generating the semantic feature vectors further comprises using the correlation scores as a regression label.
